(19) United States
(12) Patent Application Publication
(10) Pub. No.: US 2002/0075408 A1
(43) Pub. Date: Jun. 20, 2002

(54) Grid guide bookmarks

(76) Inventor: Matthew R. Curreri, Medford, NJ (US)

Correspondence Address: RATNER & PRESTIA, P O BOX 980, VALLEY FORGE, PA, 19482

(21) Appl. No.: 09/740,364

(22) Filed: Dec. 19, 2000

(51) Int. Cl. H04N 5/50

(52) U.S. Cl. 348/569

(57) ABSTRACT

A display for use with a television receiver includes bookmarks to help viewers sort through a large number of channels. The display has a channel matrix including rows and columns of channel numbers. Bookmark status is displayed on the channel matrix. The channel matrix also is used to tune the television receiver to perform other functions such as channel locking and favorite channel selection, and to display channel status such as minor channels and V-chip ratings. A viewer may select a channel and either remove its bookmark or add a bookmark. Channels displayed in the channel matrix are highlighted to indicated bookmark status. Highlighting may include visual cues such as highlighting, underlining, and displaying of icons; and audio cues. Via a remote control, viewers may view the next or previous bookmarked channel. Viewers may also view a display indicating all bookmarked channels.

### FIELD OF THE INVENTION

The invention relates generally to a display interface and more specifically to bookmarks applied to electronic program guide (EPG) displays.

### BACKGROUND OF THE INVENTION

The number of television programs that a viewer may receive at any given time has increased geometrically in the last few years. Conventional analog television systems such as those conforming to the National Television Standards Committee (NTSC) and Phase Alternate Line (PAL) standards transmit one program per 6 MHz or 8 MHz channel. Recently, digital television signal processing techniques have been developed that allow multiple programs to be transmitted in each 6 MHz channel. Furthermore, there are now many sources of television signals In addition to the conventional broadcast antenna, a viewer may receive television signals via wired cable systems, several different types of satellite systems, so-called wireless cable systems and, in the near future, via a global information network, such as the Internet.

Conventional cable television systems are capable of delivering least 140 six MHz channels and some systems are capable of delivering over 200 channels via a coaxial cable. Presently, new technology is being investigated to increase the number of programs that can be delivered to the home. This is being done via two technologically strategic moves. The first is to increase the allocated bandwidth to 1 GHz (which provides for 150, 6 MHz channels). The second is to use video compression to configure a channel to carry up to 10 minor channels in one 6 MHz wide channel. Channels that include a plurality of minor channels are also known as multiprogram channels. Typical numbers that are used in the industry estimate that about 500 programs can be delivered to the home over a single coaxial cable. Fiber optic cable provides many times the bandwidth of a coaxial cable and promise to be able to provide several thousand programs. In the same way, increased bandwidth for satellite systems may allow a viewer to receive upwards of one-thousand six MHz channels, each channel containing up to ten minor channels.

It is difficult, however, for a viewer to sort through this large number of programs. Problems are already being felt where subscribers searching through 140 programs, much less 500 or 1000. To address this problem, many of the newer television systems have on-screen menus that present the program selections organized by type. One such system uses a dedicated channel to display program schedule information. To view the information, the viewer simply tunes to the dedicated channel. The advantage of such a system is that it is relatively easy to deploy because it is centrally implemented at the transmission head-end. No additional electronics or software is required at the viewer location because full control of the display is maintained at the transmission head-end. The display information is then broadcast continuously on a dedicated channel. The television viewer simply tunes the cable converter box or television tuner to the channel on which the schedule information is displayed to view the program listings. Typically, these program guides utilize a scrolling display of television listings. Some systems employ a partial screen of listings with additional information in the remainder of the screen such as advertisements for movies on pay channels, pay-per-view event schedules, time and weather information, and other commercial information. These systems generally incorporate a grid or matrix to display the program schedule information, with a different row for each channel and columns representing different time slots.

Another type of electronic program guide uses software and/or hardware in the viewer's receiver to retrieve and process a television schedule database that is transmitted during a portion of a television channel (e.g. the vertical blanking interval). One such system is the Starsight™ service. A television receiver equipped to use the Starsight service periodically tunes to a guide channel, even when the receiver is turned off, to recover a schedule information database that is encoded in the vertical blanking interval of the television signal that is sent over the guide channel. The system then formats the data so that it may be displayed to the viewer as a hierarchical set of on-screen menus. These menus allow the user some flexibility in determining how the data is displayed. For example, program data may be displayed by type of program (e.g. sports, drama, comedy). Alternatively the viewer may select only a few favorite channels for which data are displayed.

Even with this amount of interaction, existing electronic program guide (EPG) systems may be frustrating for a viewer, especially one who has access to a large number of channels, because only a relatively small number (e.g. 10) can be viewed at any one time. If, for example, a viewer is connected to a fiber optic cable system or to a combination of a broadcast antenna, satellite dish and cable system and can receive 500 to 1000 programs, 50 to 100 screens would be needed to display all of the possible options. In addition, existing EPG systems are still somewhat difficult to use and lack features that may make them aesthetically pleasing. These deficiencies contribute to their limited use by viewers and general preference for printed television schedules.

Effective menu systems, however, are a requirement in the age of digital television. Due, in part, to the compression techniques used to squeeze up to ten standard definition television (SDTV) programs into one six MHz channel, switching among channels takes much more time on a digital receiver than on an analog receiver. It may take, for example, three or four seconds between the time the viewer selects a new program and the time any image information for that program is displayed on the receiver.

Even though the demand for channels continues to grow, it appears that many viewers are not interested in all available channels. It is not uncommon for a viewer to focus on a limited number of channels, categories, or groups of channels. Searching through several hundred channels only to view a few channels is quite frustrating.

Accordingly, there exists a need for an improved technique of displaying program information in order to make program schedule grids more readable and manageable. There also exists a need for allowing a viewer to more efficiently access and navigate desired program information. There is also a particular need for a display system that can efficiently provide the above for a system comprising several hundred to several thousand channels.

### SUMMARY OF THE INVENTION

It is to be understood that both the foregoing general description and the following detailed description are exemplary, but are not restrictive, of the invention. The present invention is embodied in a display interface for a television receiver comprising a channel matrix having n columns and m rows for displaying a plurality of channel indicators for at most n×m channels. The values n and m represent positive integers greater than two, and each channel indicator corresponds to a respectively different position in the matrix. A cursor is configured to be positioned along the rows and columns of the matrix. A channel status section displays status information on a television channel corresponding to the indicator at the position of the cursor on the matrix including whether a channel corresponding to the indicator is bookmarked or not. Also, a channel selector is included for selecting the channel corresponding to the indicator at the position of the cursor on the matrix.

According to one aspect of the invention, channel indicators in the matrix are highlighted to indicate whether a channel corresponding to the indicator is bookmarked.

Alternate embodiments of the invention include video cues such as color-coding, alternating colors, modifying fonts, and audio cues as means for highlighting a channel indicator.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a block diagram of an exemplary television system in which the present invention may be implemented;

FIG. 2 is a graphical depiction of an exemplary embodiment of a channel menu with bookmarks;

FIG. 3 is graphic depiction of a channel matrix display format having general application;

FIGS. 4, 5, 6, 7, 8 and 9 are graphical depictions of exemplary channel matrix status displays, which are useful for describing the operation of the invention;

FIG. 10 is a graphical depiction of an exemplary channel matrix in an electronic program guide that displays information about a channel in the matrix;

FIG. 11 is a graphical depiction of an exemplary channel matrix as it may be used to tune the television receiver; and

### DETAILED DESCRIPTION OF THE INVENTION

Traditional bookmarks are used to mark a page in a book, to which the reader wishes to return. This concept may also be used to aid a viewer to sort through a large number of channels. Specifically, a viewer may add channels to or delete channels from a group of bookmarked channels, and subsequently navigate through only those channels.

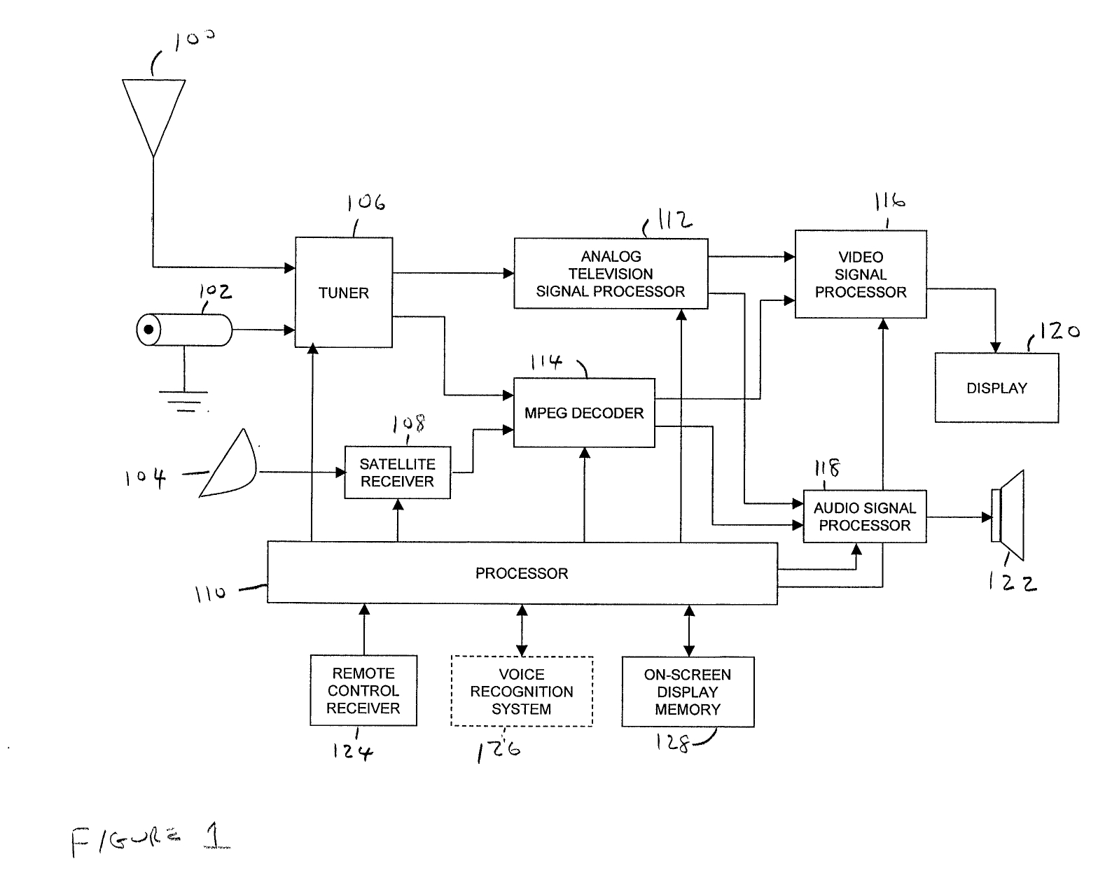

FIG. 1 is a block diagram of a television receiver system that includes an exemplary embodiment of the invention. The television receiver includes a tuner 106 that is coupled to receive radio frequency input signals from an antenna 100 and/or a cable connection 102. The system also includes a satellite receiver that receives television signals encoded according to the standard specified by the Moving Picture Experts Group (MPEG). Both the tuner 106 and the satellite receiver 108 are controlled by a processor 110. The exemplary tuner 106 may receive analog television signals or signals encoded according to the standard specified by the Advanced Television Systems Committee (ATSC). This standard is a subset of the MPEG standard. The tuner provides analog television signals to an analog television signal processor 112 and provides ATSC encoded television signals to an MPEG decoder 114. Other MPEG encoded signals provided, for example, by the satellite receiver 108 are also provided to the MPEG decoder 114. Both the analog television signal processor 112 and the MPEG decoder 114 provide analog video and audio output signals. The video output signals are applied to a video signal processor 116 while the audio signals are applied to an audio signal processor 118. The video signal processor 116 generates video images for display on a display device 120 while the audio signal processor 118 generates accompanying sounds through a speaker system 122.

The processor 110 receives remote control commands via a remote control receiver 124. This receiver may be a conventional infrared or ultrasonic remote control receiver. The processor may also be coupled to an optional voice recognition system 126 (shown in phantom) that may be used to receive voice commands from a viewer, as described below. Finally, the exemplary television system includes an on-screen display memory in which the processor 110 may build the menus and channel matrixes described below. The processor 110 is coupled to the video signal processor 116 to display these menus either on a blank screen or as an overlay on the video images that are currently being displayed.

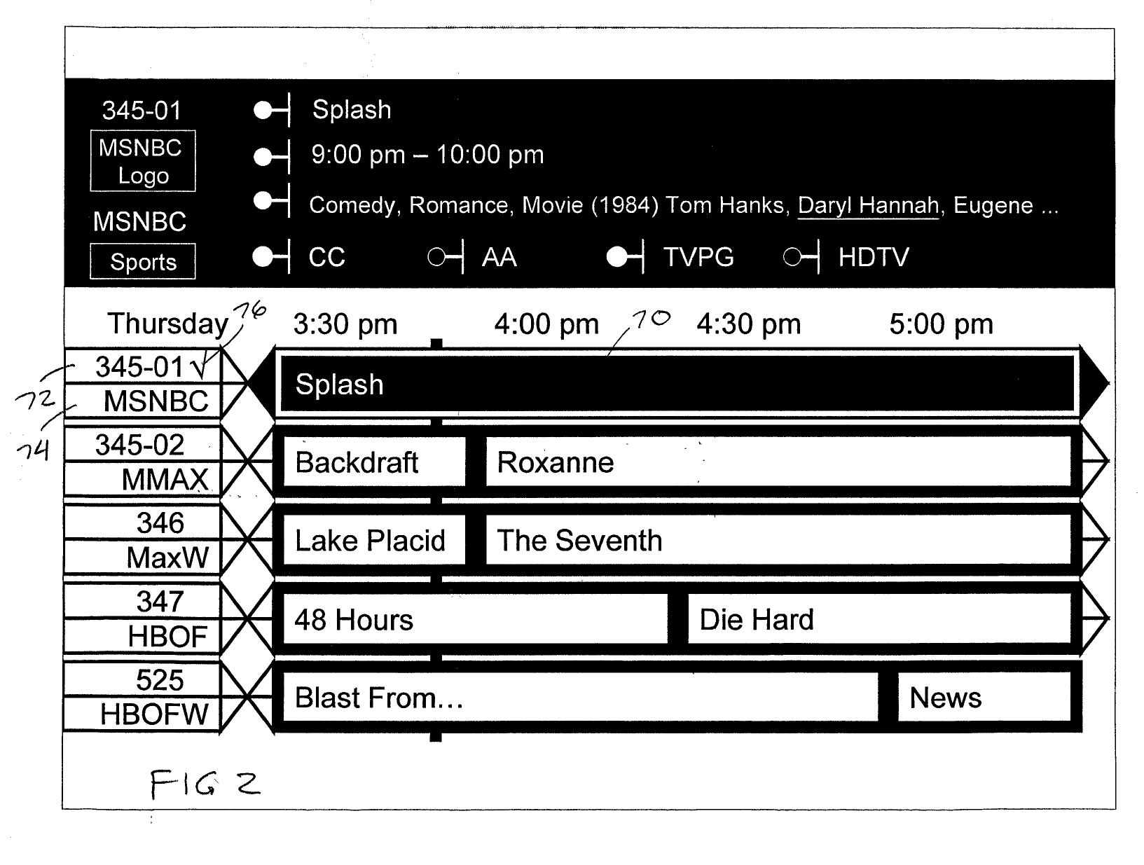

As previously stated, the large number of channels available to a viewer, coupled with the desire to navigate through a subset of available channels efficiently, make alternate methods for displaying and managing channel data desirable. A method according to the present invention uses bookmarks. FIG. 2 is a graphical depiction of an exemplary embodiment of a channel menu with bookmarks. Highlighted focus area 70, in FIG. 2, indicates that a movie entitled “Splash” is scheduled to be telecast. Display area 72 indicates that this program will be broadcast on minor channel 01 of multi-program channel 345. Display area 74 indicates that the broadcasting station is MSNBC. The exemplary check mark symbol 76 (“✓”) indicates that this channel has been bookmarked. The check mark symbol bookmark indicator 76 is exemplary only, and does not imply that other indicators can not be used.

A viewer can bookmark a channel by selecting the desired channel and pressing a bookmark key on the remote control. The bookmark key may be a single key or combination of keys. A viewer can remove a bookmark from a channel by selecting the desired channel, which has been previously bookmarked, and press the bookmark key on the remote control. A viewer can view a bookmarked channel by pressing the “browse next” or “browse previous” key on the remote control. The browse keys may be a single key or combination of keys. When a viewer presses the browse next key, the display indicates the channel number of the next higher bookmarked channel in the same display format. When a viewer presses the browse previous key, the display indicates the channel number of the next lower bookmarked channel in the same display format. In an alternate embodiment of the invention, a viewer may also add bookmarks, remove bookmarks, and view bookmarked channels by providing voice directed commands, which are detected by a voice recognition system. In this embodiment, the voice recognition system also recognizes voice directed commands to move a cursor on a display interface.

Channels are highlighted to indicate, among other things, bookmark status. It is envisioned that multiple highlighting techniques may be used (e.g., colorcoding, multiple fonts, italics, bold, blinking, and audio cues). It is also envisioned that bookmarked channels may be generated automatically from various sources (e.g., electronic program guides (EPG) databases or V-chip ratings).

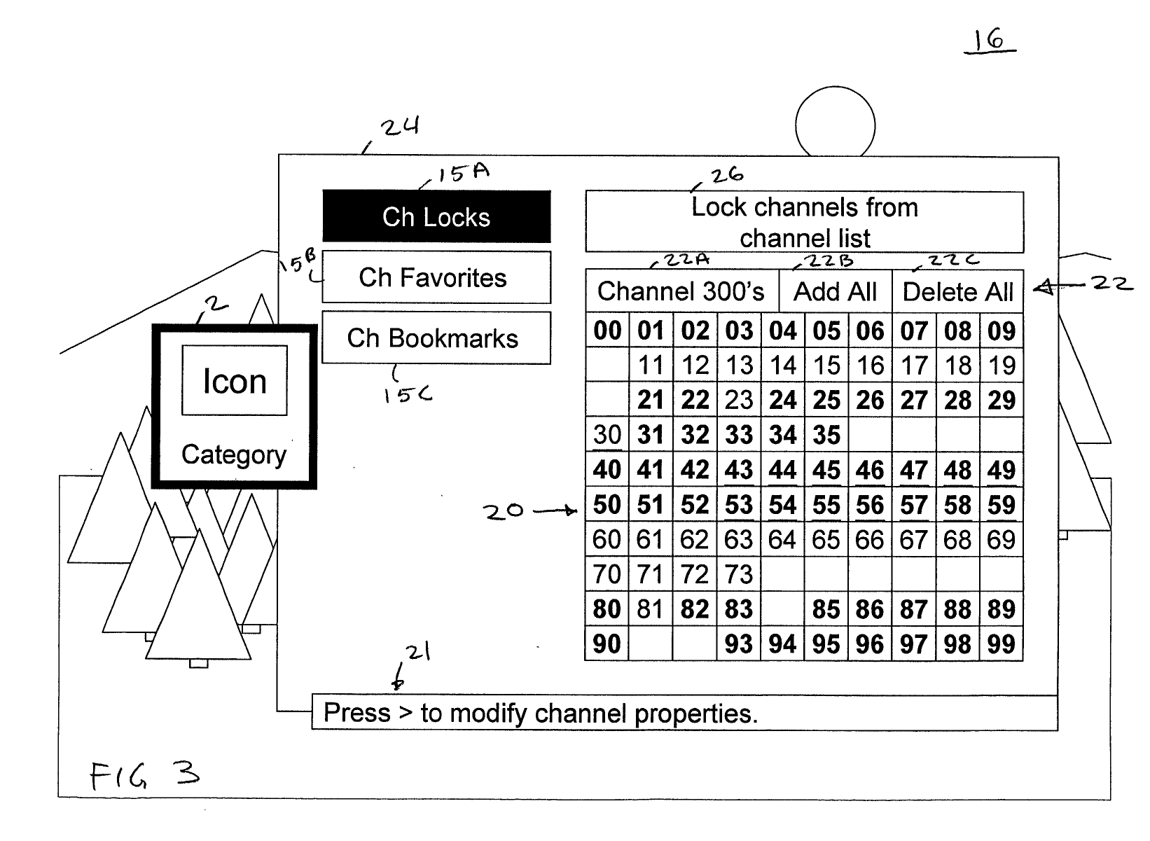

According to a second embodiment of the present invention, bookmarks may be used in conjunction with display matrices. FIG. 3 is a graphical depiction of an exemplary embodiment of a channel matrix 20 with a video image background 16. The exemplary channel matrix may be used with a number of different functions in the television receiver. The image shown in FIG. 3 may be displayed, for example, when the viewer selects such a function from a higher level menu, such as depicted in FIG. 2. The screen depicted in FIG. 3 allows a viewer to 1) determine which channels are in a particular state that is relevant to the function and 2) to modify that status on a channel-by-channel basis or for a group of channels.

The channel matrix 20 shown in FIG. 3 is a part of a channel function control display 24. The display 24 also includes, a selected channel status portion 26, a channel function category icon 2 and three channel property selectors 15A, 15B and 15C. The property selector 15A allows the lock status of the channels to be adjusted while selectors 15B and 15C allow the favorites list and the bookmark list to be edited. Each of the channel property selectors acts as a filter to allow a viewer to determine whether a particular channel has the selected property by simply viewing the channel matrix 20. Finally, FIG. 3 shows a text item 21 indicating a command that may be entered by the viewer to perform the selected function. In this example, the text item 21 indicates that to modify the channel property corresponding to the function, the viewer must press the right arrow key on the remote control.

The channel function control display 24 may be used to control a number of aspects of the television receiver. It may be used, for example, to lock specific channels (e.g. to prevent underage viewers from being able to access adult programming), to add channels to or remove channels from a favorite channels list, to show channels that are currently broadcasting a particular type of programming, to show V-chip rating information on a channel-by-channel basis for each channel in the matrix, to add or delete bookmarks, or simply to tune the television receiver.

Channel matrix 20 comprises n columns and m rows for displaying n×m channels numbers. In FIG. 3, a 10×10 matrix is shown for illustrative purposes. The channels are divided into groupings based on information contained in the channel matrix group indicator 22A. Because the exemplary embodiment of the invention displays up to 100 channels at a time in the matrix 20, the value in group indicator 22A indicates a base channel number corresponding to the 00 entry of the matrix. Thus, the channel matrix shown in FIG. 3 displays the status of the channel property identified by selector 15A for channel numbers 300 through 399.

The information displayed in the channel grid area 20 is indicated by highlighting one of the selectors 15A, 15B and 15C. If one of the sub-option selectors 15B and 15C is selected instead of the selector 15A, the channel grid area 20 may display other types of information, that may or may not be in the form of a channel grid. Icon 2 indicates the displayed information in a given channel function control display 24, relating to a particular channel function category.

In the channel grid 20, individual channel indicators are displayed at the intersection of each row and column. If a number is displayed, the channel is available. If no number is displayed at a matrix position, the channel corresponding to that position is not available for any change in its properties. For example, in FIG. 3, channel 00 is available, but channel 10 is not. The channel matrix also displays the property status of each available channel. In the exemplary display shown in FIG. 3, channels 0-9, 21, 22, 24-29, 31-59, 80, 82, 83 and 85-99 are shown as bold numbers to indicate that the have the channel property indicated by the selector 15A while the remaining channels, that do not have the indicated property, are shown in normal font. It is contemplated that other methods may be used to indicate the status of the individual channels. For example, the channel numbers corresponding to channels that have the property may be colored red while channels that do not have the property are colored green. Alternatively, only channels having the property may be displayed, other channels are displayed as blank locations in the matrix 20. It is also contemplated that different display methods may be used for different properties and that they may be combined in a single display. Thus, locked channels may be displayed in bold, channels in a favorites list may be displayed in color and channels that are not bookmarked may be not displayed in the matrix 20.

Also, a displayed channel in the channel matrix display 20 may be highlighted to indicate it is bookmarked. Highlighting may be in various forms, including color-coding, various fonts (e.g., bold, italics, shadow, underline), audio cues, flashing, or blinking. For example, if a channel is bookmarked, the background corresponding to its column and row may alternate between pink and a default color (pink blink).

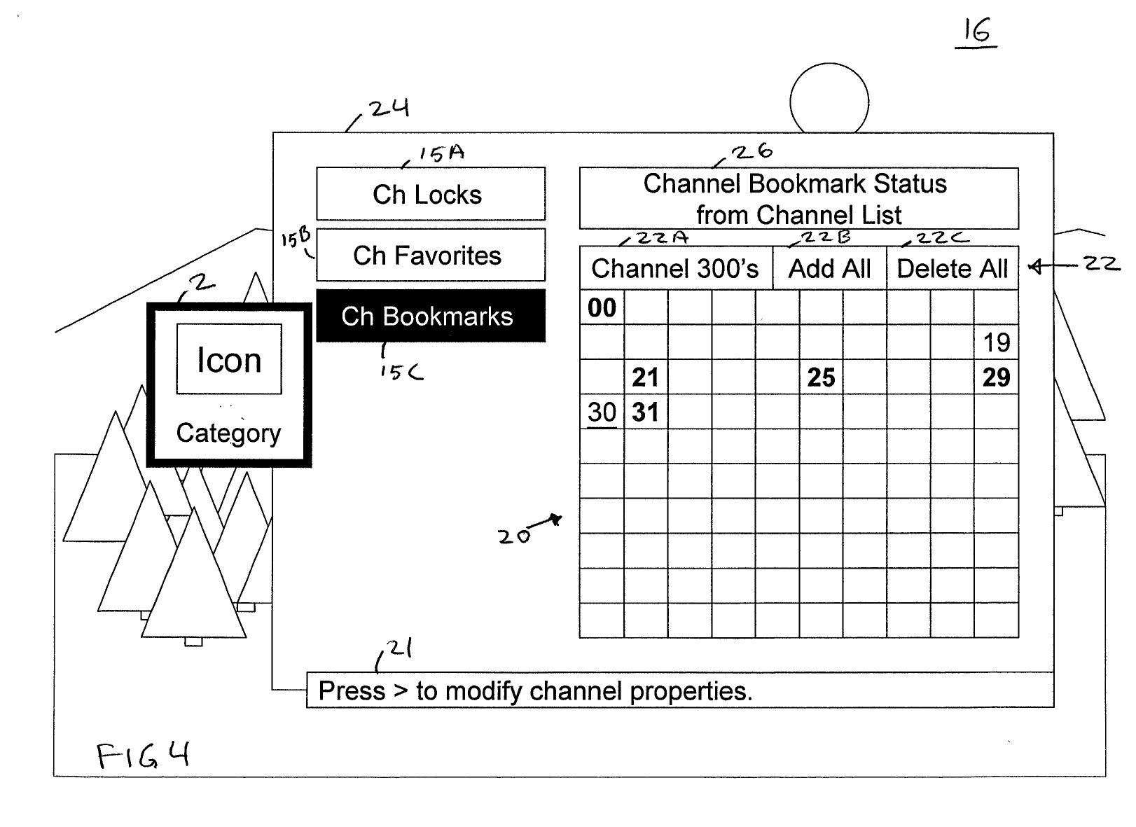

FIGS. 4 through 9 are channel matrix displays, similar to that shown in FIG. 3, illustrating the operation of the channel matrix with respect to a specific channel property, bookmarking. It is emphasized, however, that the channel grid 20 may be used in the television receiver for many other functions and to display many other properties of the channels.

The display shown in FIG. 4 may be provided, for example, in response to the viewer pressing the BOOKMARK selector in a higher-level menu (not shown). FIG. 4 shows the bookmark status and availability of channels 300 to 399. The exemplary system receives digital television signals encoded according to the MPEG standard. According to this standard, any 6 MHz channel may be configured as a single channel or as multiple minor channels. The exemplary display shown in FIG. 4 indicates the channels that include minor channels as underlined channel numbers. In the exemplary display, only bookmarked channel 30 includes minor channels. All other channels have only one program. In the exemplary embodiment of the invention, an entire channel may be bookmarked or individual minor channels in the channel may be bookmarked. To indicate that a channel has both bookmarked and unbookmarked minor channels, the display may show the channel in a different font, for example, italics (not shown) or in a different color, for example, yellow (not shown).

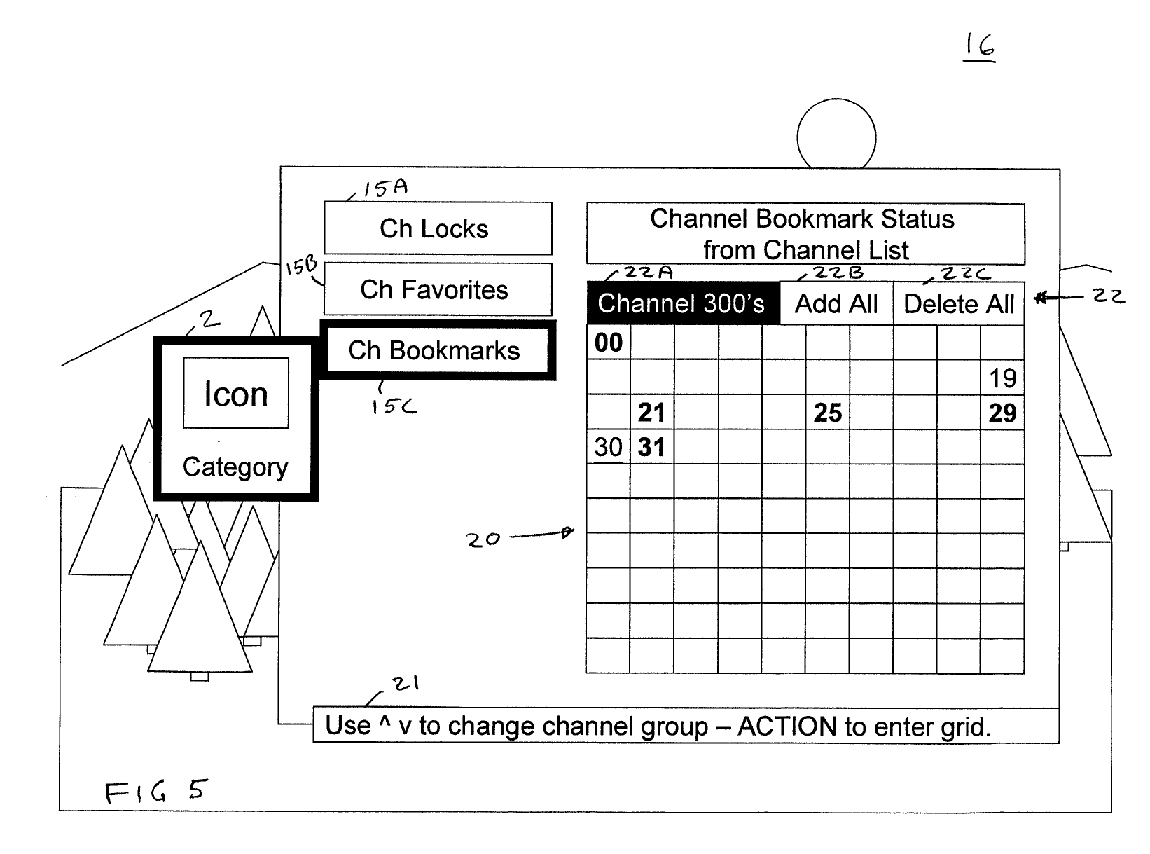

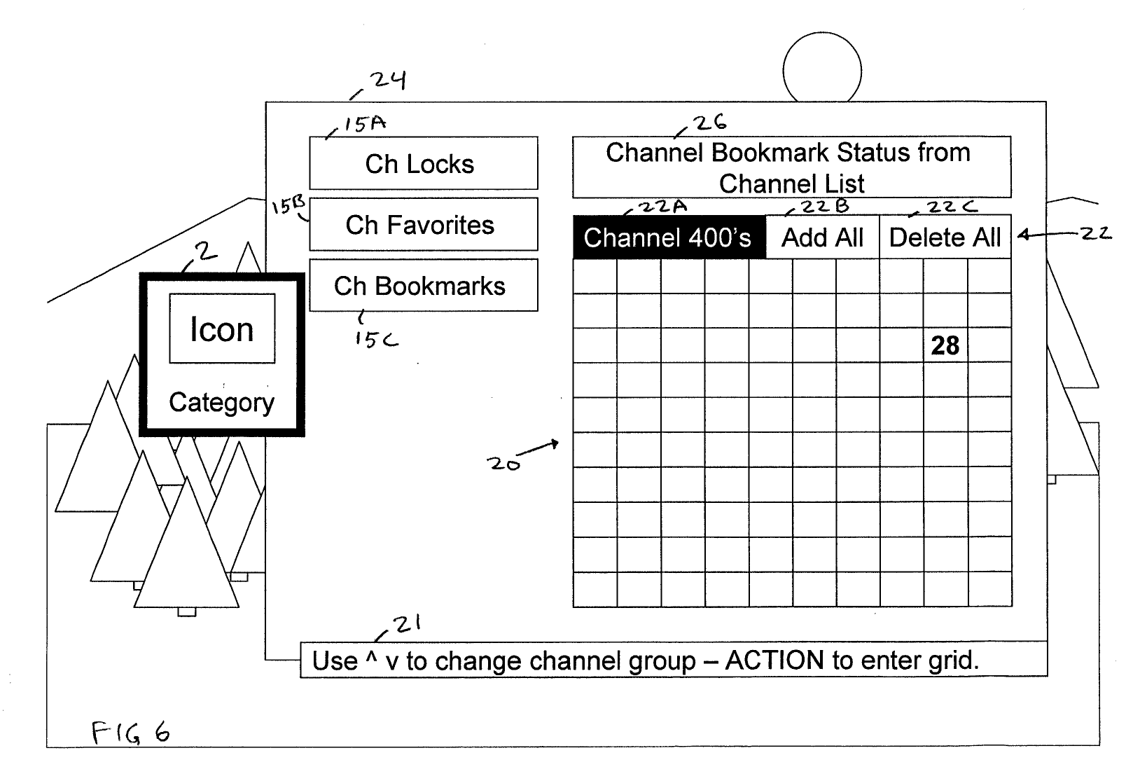

To modify the bookmark status of individual channels in the channel list from the display shown in FIG. 4, the viewer presses the right arrow key. The resulting display is shown in FIG. 5. In this display, channel group indicator 22A is highlighted and the command message 21 is modified to indicate that if the viewer presses the up or down arrow keys, the group of channels represented by the matrix 20 will change. If, for example, the viewer presses the up arrow key, the display shown in FIG. 6 is generated. This screen shows the availability, bookmark status and multi-program status of channels beginning with channel 400. In this display, the channel group indicator 22A indicates a base channel number of 400. In addition, only channel number 28 is shown in the channel matrix 20 indicating that, in the exemplary system, in the channels beginning with channel 400, only channel 428 is bookmarked.

Referring to FIG. 5, if the viewer presses the ACTION key, the viewer will enter the grid to pursue navigation of channels. If instead of pressing the ACTION key, the viewer presses the right arrow key, the selector 22B is highlighted (not shown). If the viewer presses the right arrow key a second time, the selector 22C is highlighted (not shown). By pressing the ACTION key when this selector is highlighted, the viewer may simultaneously unbookmark all of the displayed channels beginning with channel 300.

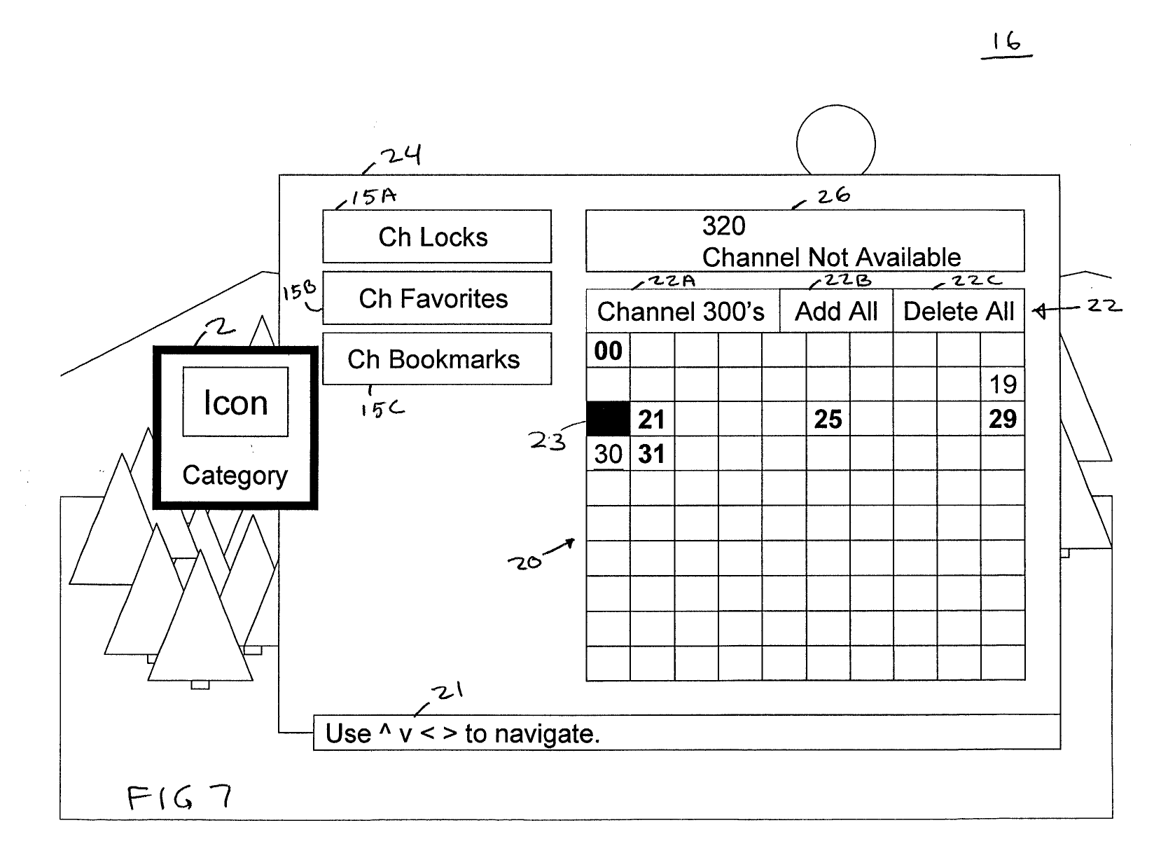

If, from the display shown in FIG. 5, the viewer presses the ACTION key to select the channel group beginning with channel 300, and presses the down arrow key three times, the display shown in FIG. 7 is provided. This figure illustrates the attempt to select a channel that is not available. Note that, in FIG. 7, the space for channel 20 is blank, indicating that this channel is not available. That is to say, it can not be received by the television receiver. When the viewer, using the arrow keys, positions the cursor 23 over the position for channel 20, the status display 26 changes to indicate that channel 20 is not available. When the cursor is active in the channel matrix, the command message 21 changes to indicate that the up, down, left and right arrows may be used to navigate through the matrix.

In an exemplary embodiment of the invention, the cursor 23 is shown as an square that reverses the color of the channel number. It is contemplated, however, that the cursor may take many different forms. It may be, for example an open square surrounding the channel number, a blinking bar beneath or above the channel number or a transparent colored square that changes the color of the channel number when positioned over the number. The positioning of the cursor may also be indicated by changing the brightness of the channel number as the cursor is moved from number to number in response to the navigation keys.

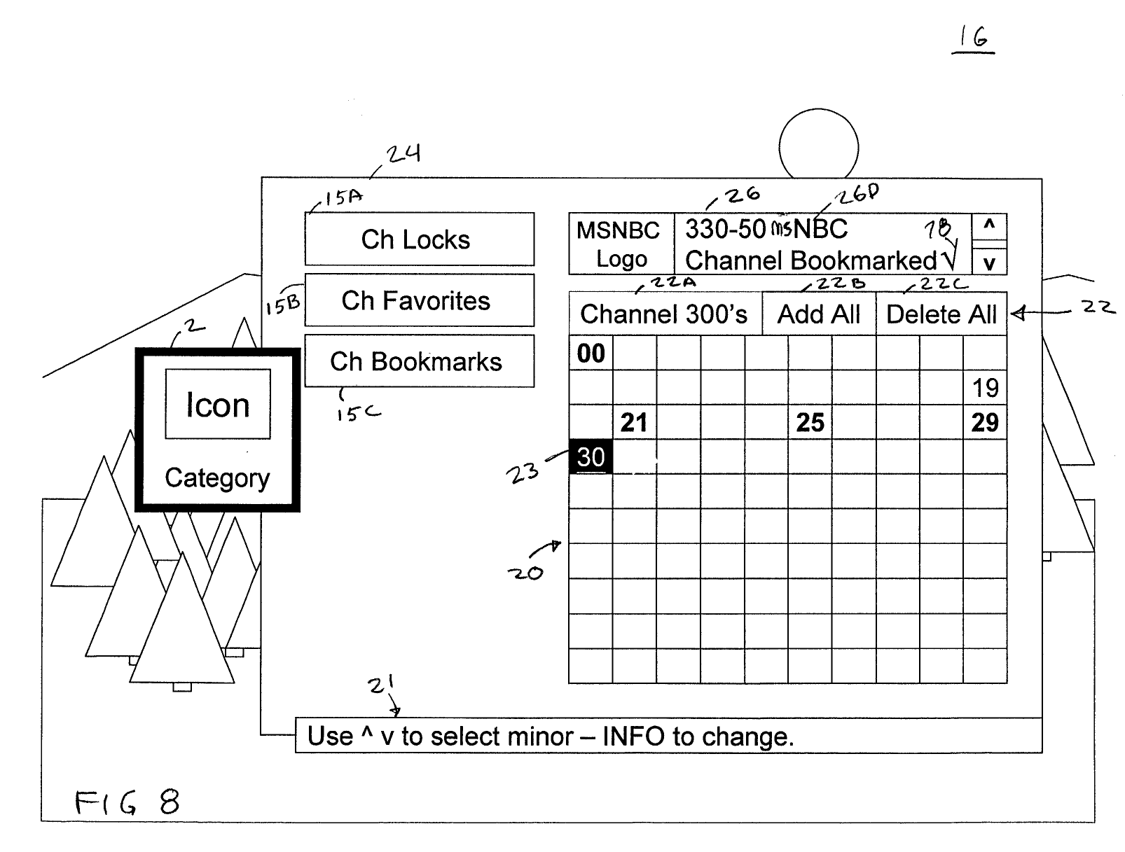

If, while the image of FIG. 7 is displayed, the viewer presses the down arrow key, the screen shown in FIG. 8 is displayed. By moving the cursor 23 down one row, the viewer highlights channel 30 which, as indicated by the underline, includes minor channels (i.e. is a multi-program channel). In this instance, channel 30 has at least two minor channels, 50 and 89. When the viewer first selects a multiprogram channel, the minor channel having the lowest number is displayed. In this instance, minor channel 50 is a MSNBC™ presentation. This is indicated by text 26D which also indicates that the minor channel is bookmarked. In addition, the channel status area includes two items 26A and 26B which indicate keys that the viewer may press to view other minor channels in the selected channel. In the exemplary embodiment of the invention, these indicators are the up and down arrows.

Referring to FIG. 8, as well as the column and row indicator in grid 20 being highlighted (as previously described), channel status area 26 indicates whether a channel is bookmarked or not. Check mark symbol 78 (“✓”) along with the message “Channel Bookmarked,” indicates that channel 330-50 has been bookmarked. Check mark symbol 78 is exemplary and does not preclude the use of other symbols and highlighting techniques. A viewer can remove a bookmark from a channel by selecting the desired channel, which has been previously bookmarked, and pressing the bookmark key on the remote control. For example, in the image shown in FIG. 8, channel 330-50 has been previously bookmarked, thus a viewer can remove the bookmark simply by pressing the bookmark key(s) on the remote control. A viewer can bookmark a channel by selecting the desired channel and pressing a bookmark key on the remote control. Selection of a channel is accomplished in any of the ways described herein. For example, from the screen shown in FIG. 8, the viewer may press the right arrow key once to select channel 331 (selection not shown). Then the viewer may press the bookmark key(s) on the remote control to bookmark channel 331. As previously described, the bookmark key(s) may be a single key or combination of keys. A viewer can view a bookmarked channel by pressing the “browse next” or “browse previous” key(s) on the remote control. The browse keys may be a single key or combination of keys. When a viewer presses the browse next key, the display indicates the channel number of the next higher bookmarked channel in the same display format. When a viewer presses the browse previous key, the display indicates the channel number of the next lower bookmarked channel in the same display format. For example, referring to FIG. 8, if the viewer presses the browse next key, and the next higher channel number that is bookmarked is channel 428, the display will change to that shown in FIG. 6, except that cursor 23 will highlight channel number 28 (not shown). If the viewer then presses the browse previous key, the grid of FIG. 8 will be displayed.

In another example, if the viewer is viewing the transmission of channel 332, which is not bookmarked, and presses the browse next key, and the next higher bookmarked channel number is channel 428, the display then changes to indicate that channel 428 is selected and being received.

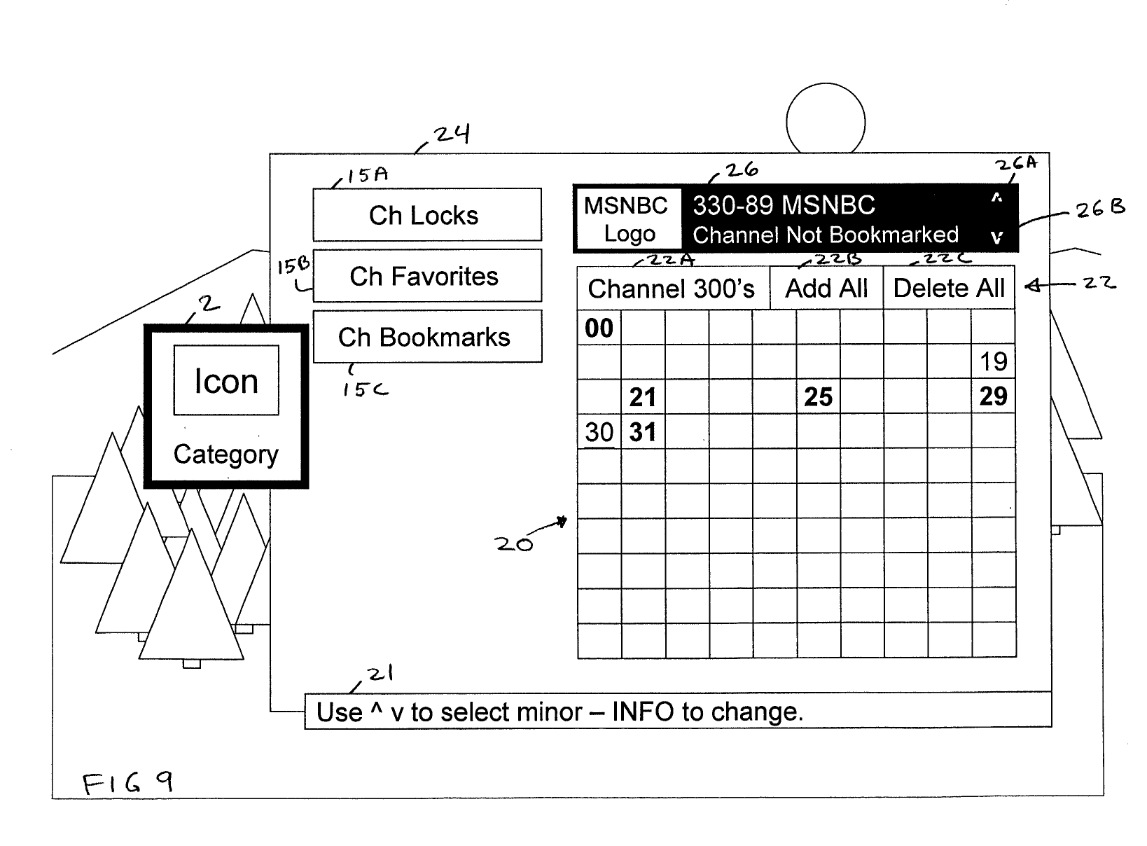

Referring again to FIG. 8, the command message 21 also changes when the cursor is positioned on a multi-program channel to indicate that the minor channels may be selected using the up and down arrows. Thus, in this exemplary embodiment of the invention, once the cursor is positioned on a multi-program channel, pressing the INFO key on the remote control highlights the channel status area 26, as shown in FIG. 9. When the channel status area 26 is highlighted, pressing the up and down arrows on the remote control causes the display 26 to progress through the minor channels. Channel status area 26 indicates that channel 330-89 is available. Also, the lack of a check mark symbol, “✓” and the message “Channel Not Bookmarked”, indicate that this channel is not bookmarked. If the viewer wants to return to the matrix 20, the viewer presses the INFO key again. While the exemplary embodiment of the invention shows using the up arrow key to display the status of the next higher minor channel and using the down arrow key to display the status of the next lower minor channel. Alternatively, to follow the channel progression of the matrix 20 with the lowest numbered channel being at the top of the matrix and the highest numbered channel being at the bottom of the matrix, the functions of the arrow keys may be reversed.

In this exemplary embodiment, when the cursor is positioned on a multiprogram channel, pressing the left or right arrow key on the remote control moves the cursor to the previous or next channel in the matrix 20 regardless of which minor channel is displayed in the area 26.

When the user is navigating in the channel matrix, the command message 21 instructs the viewer to press the ACTION key to toggle the bookmarked status of the channel. If, when viewing the display shown in FIG. 9, the viewer presses the ACTION key, the status of minor channel 89 of channel 330 is changed to bookmarked (not shown). When minor channel 89 of channel 330 is bookmarked, the channel number 30 in the matrix 20 changes to indicate that the minor channel is bookmarked. In the exemplary embodiment of the invention this may be indicated by changing the font of the channel number 30 to be bold (not shown). As set forth above, a change of this type may also be indicated in many different ways, for example by changing the color of the number or by changing the number to an italic font. In addition, it is contemplated that the color of the text item 26D may be changed to reflect the change in status. For example, the text may be red indicating the a channel is not bookmarked, and may be green indicating that a channel is bookmarked. Any other text that does not indicate bookmark status may be a different color, for example, black.

Although the exemplary embodiments of the invention have been shown in terms of a channel bookmark command, it is contemplated that the channel matrix may be used with other functions of a television receiver. The channel matrix may, for example, be used to help a viewer more quickly generate and maintain a favorite channels list. The screen displays and operation of the menu system would be much the same as for the channel bookmarking function. A sub option of the favorite channels property may be, for example, the viewer's name so that the receiver may maintain multiple favorites lists, one for each viewer in the household.

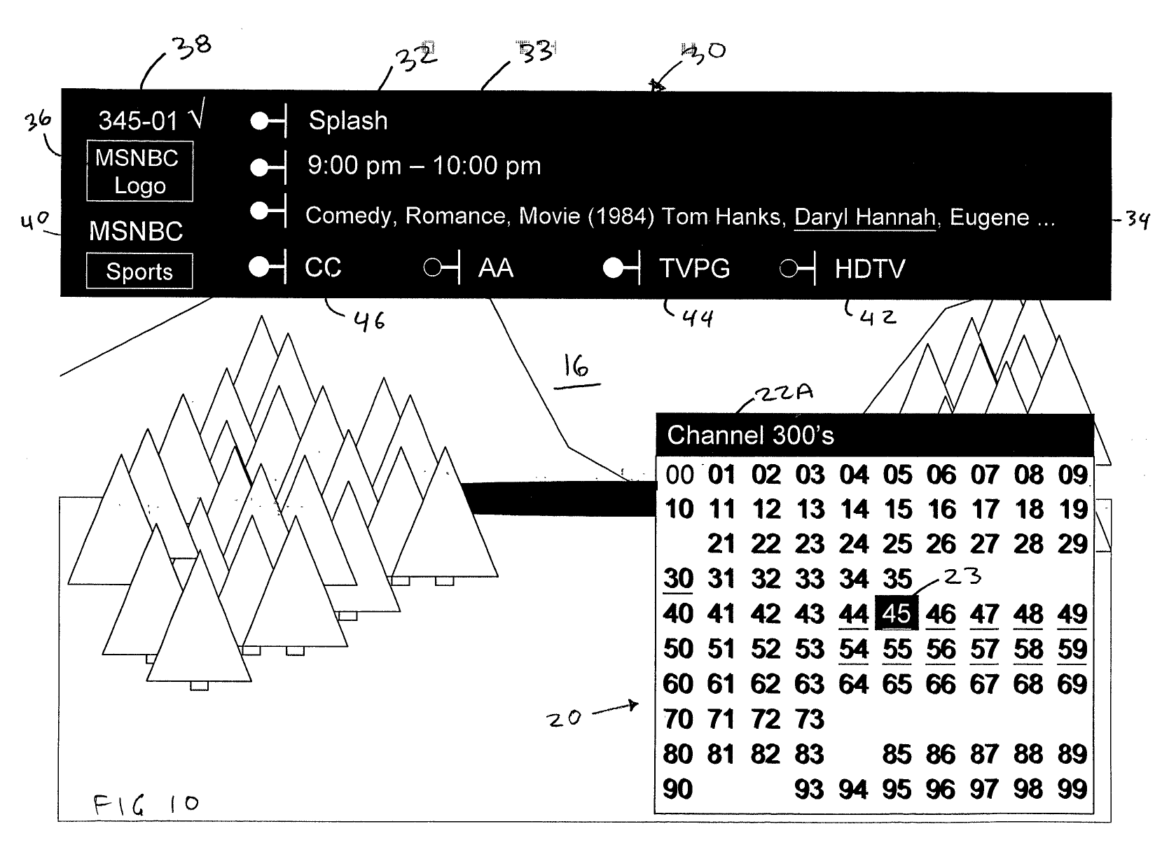

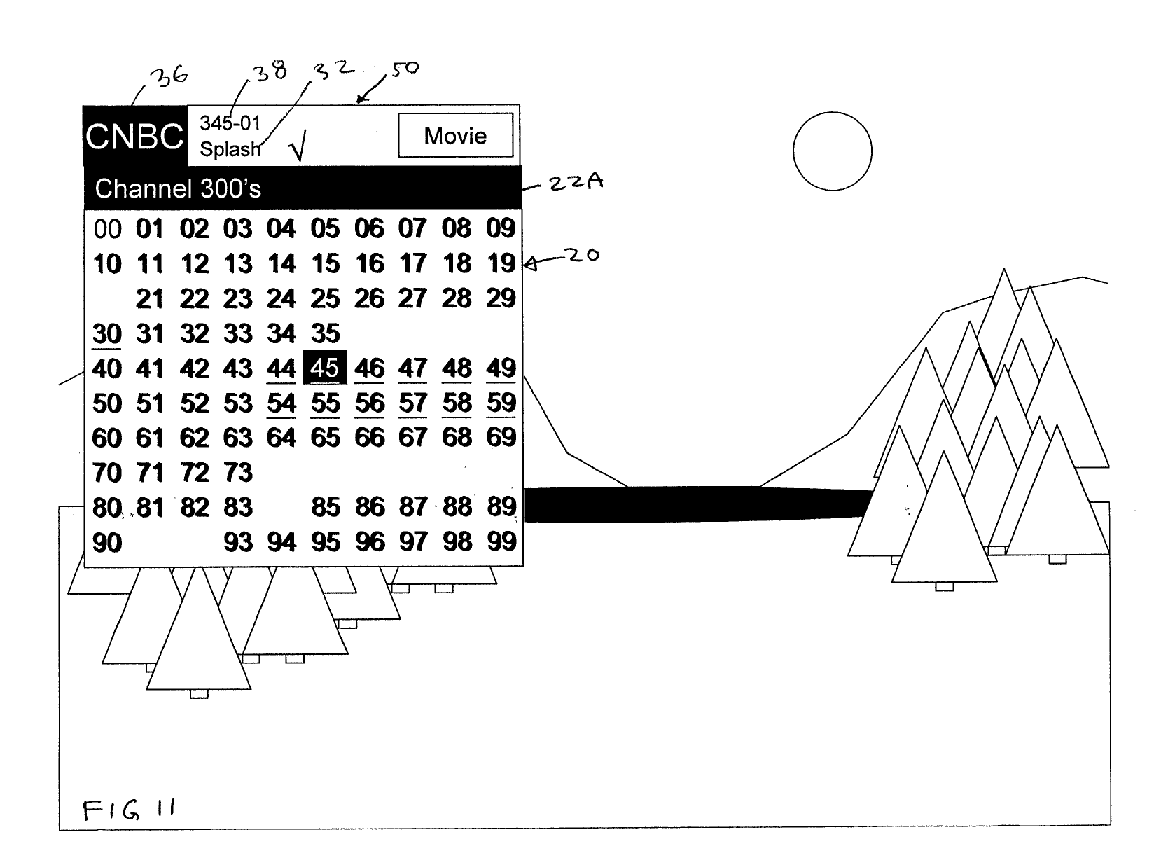

The channel matrix 20 may also be used for channel selection to tune the television receiver. FIGS. 10 and 11 are screen diagrams that show possible implementations of a channel map 20 in a selection menu. FIG. 10 shows an example of how a channel map 20 may be used to select from among the available channels in a television system. FIG. 10 includes a video image section 16 and a channel information section 30. The displayed channel is minor channel 01 of channel 345 as indicated by the value 345-01 in the channel number field 38 and by the cursor 23 being positioned on channel number 45 in the 300 channel group, as indicated by the channel matrix group indicator 22A. The check mark symbol “✓”, in channel number field 38 indicates that channel 345-01 is bookmarked. The check mark symbol, “✓”, is exemplary and does not preclude the use of other symbols and highlighting techniques. In an alternate embodiment of the invention, highlighted area 23, on display grid 20, is highlighted to indicate that at least one of the minor channels is bookmarked. Highlighting to indicate bookmark status may be in any of the previously described forms.

In this example, channel 345 may be selected by the viewer sequentially entering the digits “3”, “4” and “5” on the remote control device or, as shown in FIG. 10, by the viewer pressing a key on the remote control that brings up the channel matrix 20. The viewer may scroll through the channel groups by positioning the cursor 23 on the group indicator 22A and then moving the up and down arrow keys and the select a group as described above. Once a channel group is selected, the viewer may navigate through the channel matrix using the arrow keys. As the cursor 23 passes over each channel, the channel information section 30 of the display shows the title 32 of the program, its start and end times 33, a brief summary 34 of the program, an icon or logo 36 appropriate for the channel, call letters 40 for the channel and the channel number 38. In addition, the information section may display an indication 42 of the program format (e.g. high definition television (HDTV)), an indication 44 of the V-Chip rating for the program (e.g. TVPG) and a closed caption symbol 46 indicating that closed caption text is available. It is contemplated that other information relevant to either the program or the channel may be displayed. The background video image 16 does not change until the viewer selects a channel in the channel matrix, for example, by pressing the ACTION key while the cursor 23 is positioned over the channel number for a desired program.

It is noted that the channel numbers in the channel grid shown in FIG. 11 are modified to indicate a particular property. This property may be their bookmark status, as described above or it may be other properties such as acceptable V-chip ratings or program content.

Alternatively, the channel matrix may be used to tune the television receiver in a less intrusive manner, as shown in FIG. 11. In this use, the channel matrix 20 and channel information section 50 are both provided on a transparent background allowing more of the current video program to be seen while the viewer is selecting a new channel. In addition, the channel information section 50 is much more compact than the section 30 shown in FIG. 9. The section 50 includes only the channel logo 36, channel number and bookmark status 38, program title 32 and channel group indicator 22A. The check mark symbol “✓”, in channel number field 38 indicates that channel 345-01 is bookmarked. The check mark symbol, “✓”, is exemplary and does not preclude the use of other symbols and highlighting techniques. In an alternate embodiment of the invention, the highlighted row and column on display grid 20 indicating the number 45 is highlighted to indicate that channel 345-01 is bookmarked. Highlighting of bookmark status may be in any of the previously described forms. Otherwise, the selection system shown in FIG. 11 operates in the same way as the system shown in FIG. 9.

In an exemplary embodiment of the invention, the channel matrix 20 changes in real time to track changes in the status of the programs being sent through the channels. Channel status is tracked, modified, and updated via a channel link list. A channel link list associates channel properties. Channel properties include, but are not limited to, channel number, frequency, a lock flag, associated minor channels, a link to an electronic program guide (EPG), a link to the next higher bookmarked channel, and a link to the next lower bookmarked channel. Thus, a property is unlinked from a channel in the channel link list when a property no longer applies to a channel, and a property is linked to a channel in the channel link list, when a property applies to a channel. If for example, a major channel having multiple SDTV programs in respective minor channels changes to have a single HDTV program, the underline beneath the channel would disappear as soon as the change was detected. Furthermore, if one of the SDTV programs was bookmarked, the associated bookmark indicator would also disappear as soon as the change was detected. For example, referring to FIG. 10, the check mark symbol, “✓”, in display are 38 would disappear. Note that the minor channel indicator, “−01” in display are 38 also would disappear. Alternatively, if the matrix 20 is generated from an electronic program guide (EPG) database, the matrix would change at times indicated in the EPG database for the corresponding change in the television signal to occur. As another example, if the bookmark status is based on V-chip ratings, the channel matrix being displayed indicates the channel is not bookmarked, and a new program, having an acceptable V-chip rating is sent through a channel, the status of that channel would automatically be indicated as bookmarked. This, for example, could be implemented by changing the appearance of the channel number from non-blinking (not bookmarked) to blinking (bookmarked).

Other channel properties may affect the bookmark status of a channel. For example, if a channel is bookmarked and that channel subsequently is locked (prevented from being viewed), the bookmark status of that channel changes from bookmarked to not bookmarked. Specifically, assume a program provider transmits, within the 300's group of channels, X-rated movies during evening hours and other than X-rated movies during daytime hours. Also assume that a viewer bookmarks channel 345 (because the viewer likes the daytime movies on that channel), and locks all X-rated movies. Because the bookmark status of a channel is tracked and updated (as previously explained), during daytime hours, channel 345 is bookmarked, and during evening hours, channel 345 is not bookmarked.

In view of the convergence of television and home computers, it is contemplated that a user interface according to the present invention may be implemented in software to be run on a home computer. This software may be embodied in a computer program on a computer-usable carrier such as a magnetic disk, optical disk, radio frequency carrier wave or audio frequency carrier wave.

Although illustrated and described above with reference to certain specific embodiments, the present invention is nevertheless not intended to be limited to the details shown. Rather, various modifications may be made in the details within the scope and range of equivalents of the claims and without departing from the invention.

What is claimed is:

1. A display interface for a television receiver comprising:
a channel matrix having n columns and m rows for displaying a plurality of channel indicators for at most n×m channels, where n and m are positive integers greater than 2, each channel indicator corresponding to a respectively different position in the matrix;
a cursor configured to be moved to positions along the rows and columns of the matrix;
a channel status section which displays status information on a television channel corresponding to the indicator at the position of the cursor on the matrix, wherein said status information comprises bookmarked channel information; and
a channel selector which selects the channel corresponding to the indicator at the position of the cursor on the matrix.

2. A display interface in accordance with claim 1, wherein each channel indicator in said channel matrix is highlighted to indicate if a corresponding channel if bookmarked.

3. A display interface in accordance with claim 2, wherein highlighting comprises at least one of color-coding, modifying fonts, underlining, alternating colors, displaying symbols, and providing audio cues.

4. A display interface in accordance with claim 1, wherein ones of the bookmarked channels have at least one predetermined property.

5. A display interface in accordance with claim 4, wherein the predetermined property depends, at least in part, on information about the channels contained in an electronic program guide and the bookmarking of channels is modified at times corresponding to times at which changes in the property are to occur as described in the electronic program guide.

6. A display interface in accordance with claim 1 further including a remote control device, having at least one bookmark key for designating a selected channel as bookmarked or not bookmarked.

7. A display interface in accordance with claim 1 further including a remote control device, having at least one each of a “browse previous” and a “browse next” key for displaying, relative to a selected channel number, a next lower channel number bookmarked channel and a next higher channel number bookmarked channel, respectively.

8. A display interface in accordance with claim 1 further including a voice recognition system that recognizes voiced direction commands to move the cursor along the rows and columns of the matrix and recognizes a voiced selection command to act as the channel selector.

9. A display interface in accordance with claim 1 further including a voice recognition system that recognizes voiced direction commands to designate a selected channel as bookmarked or not bookmarked.

10. A display interface in accordance with claim 1 further including a voice recognition system that recognizes voiced direction commands to display, relative to a selected channel number, a next lower channel number bookmarked channel and a next higher channel number bookmarked channel.

11. A user interface method for bookmarking channels displayed in a channel matrix having n columns and m rows for displaying channel indicators for at most n×m channels, where n and m are positive integers greater than 2, each channel indicator corresponding to a respectively different position in the matrix, the method comprising the acts of:
highlighting channel indicators to indicate if corresponding channels are bookmarked;
moving a cursor over a channel indicator in the matrix to modify a bookmark status of a corresponding channel; and
responsive to a user command, adding or removing a bookmark from said corresponding channel.

12. A method according to claim 11 further including the act of displaying status information concerning said corresponding channel, wherein said status information includes bookmarked channel information.

13. A method according to claim 11 further including the act of, responsive to a user command, displaying, relative to a selected channel number, one of the next higher or next lower bookmarked channel number from the channel number corresponding to a current cursor position.

14. A method in accordance with claim 11, wherein the act of highlighting comprises at least one of color-coding, modifying fonts, underlining, alternating colors, displaying symbols, and providing audio cues.

15. A method in accordance with claim 11, further including the act of bookmarking all channels having a predetermined property.

16. A method in accordance with claim 15, wherein the predetermined property depends, at least in part, on information about channels contained in an electronic program guide and the step of bookmarking includes the act of bookmarking at times corresponding to times at which changes in the property are to occur as described in the electronic program guide.

17. Apparatus for bookmarking channels displayed in a channel matrix comprising:
means for displaying said channel matrix having n columns and m rows for displaying channel indicators for at most n×m channels, where n and m are positive integers greater than 2, each channel indicator corresponding to a respectively different position in the matrix;
means for highlighting channel indicators to indicate if corresponding channels are bookmarked;
means for moving a cursor over a channel indicator in the matrix to modify a bookmark status of a corresponding channel; and
means for, responsive to a user command, adding or removing a bookmark from said corresponding channel.

18. Apparatus in accordance with claim 17 wherein the channels corresponding to the indicators in the matrix may have first and second configurations and the apparatus further includes means for modifying the channel indicators corresponding to channels having the first configuration and not modifying the channel indicators corresponding to channels having the second configuration.

19. A computer readable carrier including a computer program that controls a computer to implement a user interface method for bookmarking channels displayed in a channel matrix, the computer program causing the computer to perform the steps of:
displaying said channel matrix having n columns and m rows for displaying channel indicators for at most n×m channels, where n and m are positive integers greater than 2, each channel indicator corresponding to a respectively different position in the matrix;
highlighting channel indicators to indicate if corresponding channels are bookmarked;
moving a cursor over a channel indicator in the matrix to modify a bookmark status of a corresponding channel; and
responsive to a user command, adding or removing a bookmark from said corresponding channel.
